(19) United States
(12) Patent Application Publication
(10) Pub. No.: US 2009/0167599 A1
(43) Pub. Date: Jul. 2, 2009

(54) Location Based Services Information Storage and Transport

(75) Inventors: Roderick Michael Johnson, Scottsdale, AZ (US); Dane Blackwell, Calgary (CA); Brad Scheurman, Calgary (CA); Dennis Needham, Calgary (CA)

Correspondence Address: FISH & RICHARDSON P.C., PO BOX 1022, MINNEAPOLIS, MN, 55440-1022, US

(73) Assignee: CORTXT, INC., Scottsdale, AZ (US)

(21) Appl. No.: 12/197,128

(22) Filed: Aug. 22, 2008

Related U.S. Application Data
(60) Provisional application No. 60/957,632, filed on Aug. 23, 2007.

(51) Int. Cl. G01S 1/00

(52) U.S. Cl. 342/357.09

(57) ABSTRACT

Methods, systems and computer program products for providing an adaptive active location information gathering algorithm are described. Specifically, significant information density gains can be achieved by using an adaptive active location information gathering algorithm. The adaptive algorithm may select a compression and decompression encoding appropriate to deliver maximum information density while being adjusted automatically to accommodate variations including velocity and duration changes within a defined reporting period to ensure versatility and maximum efficiency.

### CROSS-REFERENCE TO RELATED APPLICATIONS

This application claims priority to U.S. Provisional Application Ser. No. 60/957,632 titled “Location Based Services Information Storage And Transport,” filed on Aug. 23, 2007, the disclosure of which is incorporated herein by reference in its entirety.

### TECHNICAL FIELD

The subject matter of this application is generally related to location-based systems.

### BACKGROUND

The NMEA (National Marine Electronics Association) standards for presenting GPS location information have offered GPS and Geographic Information Systems (GIS) vendors a broadly understood and acceptable published standard of information formatting which the industry can conform to. In the early stages of commercialization of GPS, there was little economic rationale for pursuing new methods to store, transport and present location information. The emerging mobile LBS industry now widely uses these NMEA data standards, which have been broadly incorporated for most, if not all application-based services.

Typical data compression algorithms, such as those found in PK, ZIP, and PAQ codec's, use mathematical reduction algorithms or tokenization to represent data patterns that repeat throughout a data file to reduce the number of bytes necessary to store and/or transport data files. The compressibility and therefore possible compression ratios using these methodologies naturally vary considerably in response to the nature and amount of information contained in the data being processed. These conventional methods are designed and optimized to work reasonably well on generic data files, independently of the type of information involved.

### SUMMARY

Methods, systems and computer program products for providing an adaptive active location information gathering algorithm are described. Specifically, significant information density gains can be achieved by using an adaptive active location information gathering algorithm. The adaptive algorithm may select a compression and decompression encoding appropriate to deliver maximum information density while being adjusted automatically to accommodate variations including velocity and duration changes within a defined reporting period to ensure versatility and maximum efficiency.

In some implementations, a method includes determining a first location of a device. Based on a trigger, a second location of the device is determined. A data representation associated with the first location and second locations are compressed as an initial location and an offset from the initial location, where the offset is an angle and a distance. The method includes transmitting location information associated with the initial location to a remote device.

In some implementations, a method includes determining an adaptive interval when to record location information associated with a device without requiring a user to select a fixed time interval or a fixed distance interval in advance, recording location information at each interval in the adaptive interval, compressing the location information, and transmitting the compressed information to a receiving device.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A shows a schematic view of an example GPS network.

FIG. 1B shows a block diagram of an example codec.

FIG. 2 shows a change of distance change “dD” and a change of angle “dA” with respect to a difference between a first interval and a second interval.

FIG. 3 shows an interstate highway connecting Las Vegas and Los Angeles.

FIG. 4 shows an example of a route with an evenly spaced plot.

FIG. 5A is a flow diagram showing an example process for compressing location information.

FIG. 5B is a flow diagram showing another example process for compressing location information.

FIG. 6 is a block diagram of generic processing device that may be used as a GPS assisted device.

Like reference symbols in the various drawings indicate like elements.

### DETAILED DESCRIPTION

### System Overview

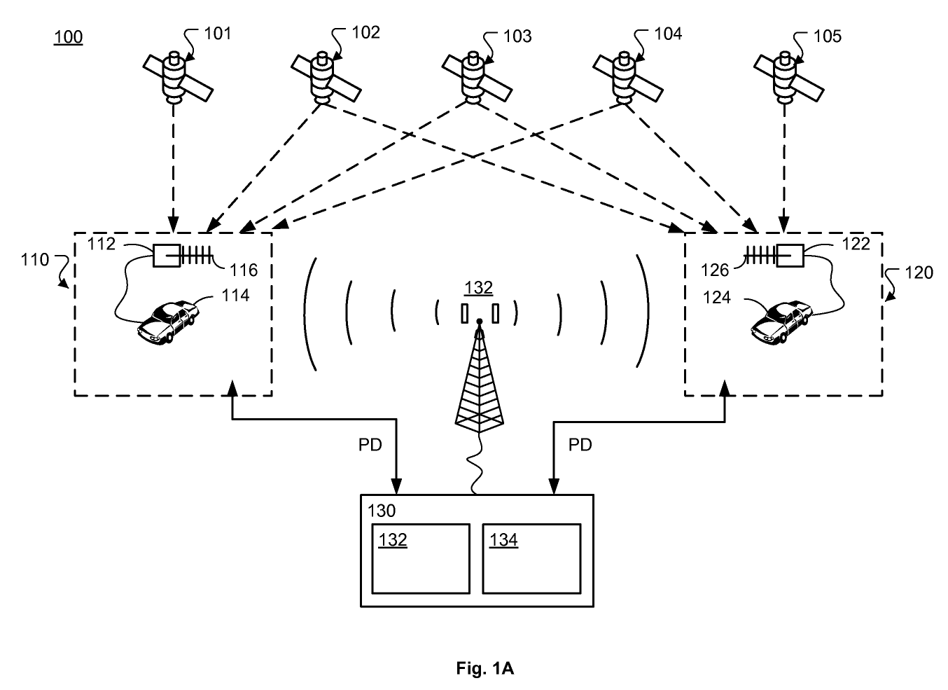

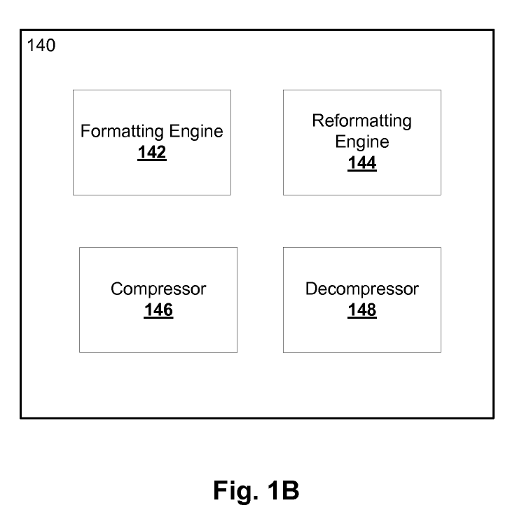

FIG. 1A shows an illustrative network 100 with a base station 130, a mobile unit 200, a mobile unit 300, and communication device 132. Although only two mobile units are shown, one skilled in the art would recognize that there may be multiple mobile units. Also shown in FIG. 1A are satellites 101, 102, 103, 104, 105. Any one of the satellites may identify and provide the geographic position (i.e., location, altitude, and optionally a moving direction and/or moving speed) of the mobile units using the positioning information data PD.

As shown, the base station 130 generally includes a central processing unit 132, and at least one storage unit 134, and depending on the situation, may function as server or client. A communication device 132 of the base station 130 may include a connection connecting the base station 130 to a mobile wireless network, which can be used by a large number of mobile units. Connections to other wireless networks can also be implemented, (e.g., connections to deep-sea vessels or to mobile devices in areas where no mobile wireless networks are available). The base station 130 itself can be connected over the Internet, over direct data lines or over wireless networks to the telephone or data networks of one or multiple mobile wireless providers, so that the base station 130 can establish connections to mobile units in different telephone and/or other wireless networks. In some implementations, unidirectional, bi-directional or multidirectional connections or data exchange between the base station 130 and the mobile units 110/120 are possible.

In some implementations, the mobile units 110/120 may include a vehicle 114/124 with at least one (internal or external) satellite or global positioning system receiver 112/122 (e.g., a GPS receiver), each with at least one corresponding antenna 116/126. Other navigation systems on ships, in aircraft or installed in mobile devices such as cellular phones also may be used. While the receiver 112/122 may receive GPS information, the receiver 112/122 also may transmit signals to the satellites 101-105, to another mobile unit(s) or base station 130. The antennas 116/126 may be any kinds of antennas suitable for receiving signals transmitted by satellite positioning system satellites. The satellite positioning system receivers 112/122 and the antennas 116/126 may be suited to receive satellite signals transmitted by one or multiple satellites 101-105, which may be part of a satellite system (or multiple satellite systems) to determine a geographic location of a mobile unit (e.g., NAVSTAR-GPS satellites).

In some implementations, each satellite may operate with spread-spectrum technology. Specifically, each satellite may transport C/A code (“Coarse/Acquisition”) for commercial use and a navigation message. The transmitted C/A code may be a pseudo-random, 1023 bit long code, which may be unique for every satellite. Due to this “pseudo-random noise” (PRN) these signals may be less susceptible to interference.

For the initialization of devices, an almanac may also preferentially be transmitted. In some implementations, there may be 24 satellites in the GPS network 100, and each of the 24 satellites may send almanac data of other satellites. The almanac data may contain particular information about the ecliptic parameters of all satellites, their technical condition, identification numbers, and the like. From the almanac data, the receivers 112/122 may identify and/or deduce which satellites are likely to be in a line of sight, and so can limit associated geographic search only to the identified satellites.

The mobile units 110/120 may supply the base station 130 with information data set PD from one or multiple satellites 101-105. The mobile units 110/120 also may include a central processing unit to process and analyze the received data. The analyzed or processed data may then be stored again. The stored data—which may be raw data received in the form of satellite signals, or analyzed or processed data—may be read by the mobile units 110/120 from, for example, respective memory and made available to the base station 130 as information data PD.

In some implementations, information data PD may contain, for example, components of almanac data, ephemeris data or identification data for individual satellites 101-105 from which signals have been received. Information data PD also may contain information about the geographical position of the satellite receiver 112/122 and its antenna 116/126, information about the reception quality of the satellite signals from individual satellites 101-105, or time references. If a mobile unit has received a navigation message, it can make any data included in the navigation message available within the scope of an information data PD. If desired, in certain implementations, only information in regard to individual satellites 101-105 may be made available.

The mobile units 110/120 may establish a connection to the base station 130 through its communication device 132, and send or exchange information data PD. Wireless-specific data protocols which may be used during information exchange include, without limitation, wireless application protocol (WAP), general packet radio service (GPRS), circuit switched data (CSD), high speed circuit switched data (HSCSD), SMS, UMTS, CDMA, WCDMA, or other standards. The mobile units 110/120 also may include WLAN or Bluetooth units that enable the units to communicate via WLAN and/or Bluetooth with a base station or other mobile units.

In the illustration shown in FIG. 1A, the mobile unit 200 may receive signals from four of the five satellites 101-104, and the mobile unit 300 also may receive signals from four of the five satellites 102-105. As noted earlier, the GPS network 100 may include 24 satellites located on six orbits around the earth. A satellite receiver 112/122 with a good line of sight to the sky may receive on average signals from eight satellites.

Due to interference from buildings, weather conditions or the location itself, fewer satellites 101-105 may be visible and a mobile terminal 110/120 that generally receives signals from five satellites may only receive data from four satellites under such conditions. After receiving satellite data, the mobile units 110/120 may process the received satellite data and/or to provide or communicate the satellite data in whole or in part unchanged as information data PD to the base station 130.

The mobile units 110/120, in some implementations, may analyze the received satellite data and determine their respective geographic location, and then supply or transmit the current ephemeredes of the individual satellites 101-105 and/or additional information, (e.g., the receiving time, receiving location and/or at least a part of the almanac data) as information data PD to the base station 130.

The base station 130, in some implementations, may recognize that the information data PD contains one or more satellite signals that have not been processed (e.g., in raw form) or that the data has already been processed by the respective mobile units 110/120. In some implementations, the base station 130 may detect and (further) process different formats of the received information data PD. Depending on the type of the unit, the information data PD can initially be stored unchanged and processed further at a later point in time, optionally depending on data received by other mobile units. In the same manner, the information data PD, after having been received, may immediately be analyzed, broken down into individual data components, and subsequently stored. For example, individual components (e.g., ecliptic data of individual satellites) may be stored, and optionally with data referring to the time when the information data was received, the location of the antenna 116/126 at the time when the satellite data were received, and/or other data.

In FIG. 1A, the mobile units 110/120 may be supplied with positioning data (e.g., the ephemeris data) for the satellites 101-105, and in addition other positioning data (e.g., ephemeris data) from other satellites if already stored or available in the base station 130. If the mobile units 110/120 have already been notified which satellites 101-105 (e.g., satellites 102-104) are currently in its window of sight, then in conjunction with a request for positioning information data PD, the positioning information data PD may be limited to three satellites 102, 103, 104 that are located inside this window of sight. In addition or alternatively, at least a part of the almanac data regarding other satellites actually or potentially located in the field of sight may also be supplied or transmitted to the mobile units 110/120.

In some implementations, the mobile units 110/120 may be configured so that the base station 130 may notify an mobile unit if and under what conditions the mobile unit shall transmit the information data PD to the base station 130. Such notification may take place together or in conjunction with the provision of positioning data to another mobile unit.

### Compression Codec

In some implementations, a codec 140 may be provided in each mobile unit 110/120. The codec 140 also may be implemented as a component of the satellites 101-105 and base station 130. As will be discussed in greater detail below, the codec 140 may be used to compress NMEA-type location information for storage and/or transport. The compressed information may then be decompressed by a same (or different) codec for presentation to other applications which utilize NMEA-type data formatting. Variants of the basic algorithms contained in the codec optimize for application specific information compression.

Conventional NMEA location protocols use an ASCII, comma delimited format that results in a packet of approximately 60 bytes per location. To bring the payload to slightly less than half the bytes of the standard NMEA format, conventional solutions alter the NMEA format by removing redundant characters and then converting from an ASCII to binary format. Transporting large amounts of location information, such as the complete route history of a commercial vehicle, may be performed in a file or packet, where the sequentially concatenated locations essentially describe a route history over a period of time. This type of packet compression strategy is able to achieve average location information densities of approximately 30 bytes per location, or roughly at a 2-to-1 compression ratio.

As will be discussed in greater detail below, a codec 140 that logarithmically increases location information density, where average location descriptions may be as small as 14 bits (1.8 bytes), or in excess of a 30-to-1 compression ratio as compared to the NMEA standard, may be provided. This allows an NMEA compatible file containing 60 to 80 locations that would typically be 3600 bytes to 5000 bytes in size to be sent via an SMS message. The receiving codec then may deliver the NMEA compatible file to an LBS application for further processing.

### Adaptive Algorithm

At a high abstract level, certain LBS applications (e.g., vehicle or child tracking) require each individual location recorded to have a unique time component to provide the information required by the LBS application. For other LBS applications such as route geometry, or POI, such a time component is not required, creating additional opportunities to increase the information density a particular data payload can achieve. LBS applications that typically require the transport of a large amount of time sensitive active location information on a regular basis generally track services that record historical location information.

Conventional systems use several primary techniques to record, store and transport active route or history information that also incorporate a time component as a requirement to fully value the information provided. These techniques are listed below in TABLE 1:

TABLE 1

| | |
|---|---|
| Start and | the application transmits the time and location of a |
| Stop | stop or start |
| reporting | |
| Fixed Time | the application records the time and location over a |
| Interval | fixed period of time, such as once every |
| | 15 minutes or 1 hour |
| Fixed | where the application only reports a new location when it |
| Distance | recognizes that a new location exceeds a fixed distance |
| Interval | threshold, such as 500 meters |
| Hybrid | typically where Start/Stop reporting and either Fixed Time |
| Reporting | Interval or Fixed Distance Interval information are both |
| | included in the data transmitted by the application |

Conventional systems typically require a user to select a fixed time interval, or a fixed distance interval in advance in an attempt to strike a reasonable balance between the amounts of useful information requested, with a secondary goal to minimize the volume of data being transmitted by the application (e.g., mobile application) in the course of travel, based on the user's selection. These settings may be established using typical movement patterns that will statistically result in the best overall application performance. Therefore, settings associated with tracking a long haul trucking application would necessarily be different than those associated with a child-tracking application where velocities and distances are likely to be reduced.

Thus, in some implementations, the codec 140 may utilize an adaptive algorithm. Specifically, significant information density gains can be achieved by using an adaptive active location information gathering algorithm. The adaptive algorithm considers the interpretive value of the flow of GPS information available to reduce the number of individual locations required to achieve the overall goals of the application, before subsequent information density enhancements. The adaptive algorithm removes the need to manually set or adjust the algorithm for each type of application, and performs better than a fixed algorithm, as the adaptive algorithm adjusts automatically to wide variations to overall velocity and duration changes within the defined reporting period.

### High Level Codec Description

As discussed above, a codec 140 may be provided in each mobile unit 110/120. The codec also may be implemented as a component of the satellites 101-105 and base station 130. FIG. 1B shows a block diagram of an example codec 140.

In some implementations, the codec 140 may include a formatting engine 142 to create a reduced data payload, and a reformatting engine 144 which reassembles and reformats the information for use by the associated LBS service applications it is supporting. The codec 140 can be installed on a mobile device, or stationary device such as a network server or standalone LBS application server, depending on the direction of information flow required and the type of services being supported. The codec 140 may be implemented as software, firmware, or as a chip level implementation.

The compressor 146 of the codec 140 may be used when the codec formatting engine 142 encodes the information payload. In this instance, this reduced payload is called the “compressed packet”. Similarly, the decompressor 148 may be used when the codec 140 decodes and reformats the compressed packet for delivery to LBS or other types of applications. In implementations where active location information codec sessions are being referred to, it may be assumed that the adaptive algorithm of the codec 140 may run on a mobile device, and determine as to when to record a new location from the flow of GPS information available. It also may be assumed that the compressor 146 of the codec 140 may choose an encoding mode appropriate to deliver maximum information density. Of course, such a configuration is merely illustrative, and that other configurations also are contemplated.

In some implementations, the compressor 146 encodes the compressed packet with one or more indicators that allow the decompressor 148 to decode the packet based on the one or more indicators, which may provide, for example, the type of encoding used and the type of reformatting required. In some implementations, the codec 140 may be embedded in a GPS tracking device where the algorithm and compressor encoding decisions are made, and a compatible version of the codec 140 may reside on a server. For sake of simplicity, a “tracking device” is assumed to be a GPS device that is permanently mounted to a vehicle. Of course, the tracking device would also apply to other applications such as, without limitation a mobile phone or portable navigation device (PND) and the like.

In some implementations, when optimizing the information density of a number or series of locations, the same basic information compression rules may apply (e.g., whether describing an actively gathered route, a turn-by-turn route geometry, a POI location listing, a buddy location listing, etc.). In some implementations, high information density may be achieved by organizing the individual locations in a manner that best describes the relationship between the locations, rather than describing the locations themselves. In some implementations, the codec 140 may examine all the locations that are available, and organizes the locations (e.g., using an organizational structure) in a sequence that minimizes the total spatial distances between the locations. Furthermore, as the location density increases (e.g., within the organizational structure), the information required to describe these relationships may decrease, allowing the use of smaller bitwidth binary values to represent the spatial relationship between the individual locations.

One active location information example of such an organizational structure may be a route, as the route may represent a series of locations with relatively short times and distances between the locations, and as the distances may be limited by either the time interval or theoretical peak average velocity of the moving object during that interval. One example of an optimal organizational structure of a passive location grouping may include an instance in which a user types in a current location to a POI application that returns a group of interest points that are a short distance away from the user's known current location.

### Location Compression-Distance and Angle and Differences Representation

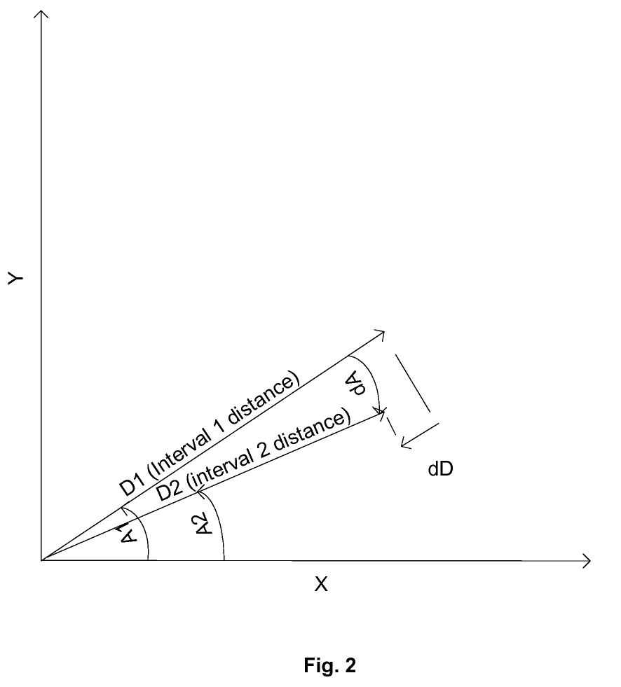

When more than one location, whether active or passive, is considered, any subsequent locations may be described, for example, as a distance and angle from the last location. For sake of simplicity and brevity, these distances and angles may be referred to as intervals with respect to the total change (i.e., the “delta”) of the interval. For each interval, the compressor 146 may calculate a distance and angle change from the last location. FIG. 2 shows a change of distance change “dD” and a change of angle “dA” with respect to a difference between a first interval and a second interval. Also, in FIG. 2, X axis represents longitude and Y axis represents latitude, and distance D1 and distance D2 represent the magnitude of the latitude and longitude in degrees associated with the first interval and the second interval, respectively. In some implementations, distance D1 and distance D2 may each be calculated as D1=√(dLat²+dLong²)) or D2=√(dLat²+dLong²)).

In some implementations, units referenced by the compressor 146 of the codec 140 may be in geographic degrees. In some implementations, map calculations and those associated with used by GPS devices also may use degrees to measure coordinates. In other implementations, kilometers or miles may be used as the units referenced by the compressor 146.

It should be noted that a conventional NMEA packet generally describes a location anywhere on Earth; whereas FIG. 2 shows an interval (e.g., the first interval or the second interval) describing a vector including a small angle and distance compared to full angles and distances. Also it should be noted that the change of distance “dD” and the change of angle “dA” are negative in this example (e.g., which may require sign bits). As an example, if the change of distance “dD” is smaller than ⅛ of the maximum range of distance, and the change of angle “dA” is smaller than 1/16 of the maximum range of angle, then the codec 140 may perform a mode change to implement the change of distance “dD” and the change of angle “dA”. In this example, the bit width for the distance may be 3 bits smaller than a normal distance and the bit width for the angle may be 4 bits smaller than a normal angle.

### Determining an Appropriate Bitwidth and Resolution of the Delta for an Interval

To represent the relationship between an initial location, and a new location in a subsequent interval, in some implementations, the codec 140 may create alternative information to replace the actual location in question. In some implementations, a vector may be used that describes the angle and the square root of the distance between the original location and subsequent location. The distance value may then be converted to an integer (e.g., a 10-bit integer). The angle also may be converted to an integer (e.g., a 12-bit integer).

In some implementations, a 10-bit value may be used rather than a 12 bit value to describe the distance, as the square root of the distance may allow 10 bits to provide high resolution when the distance may be small (or large). This is because the square root of the distance value being used naturally may create a large enough range, which may not be feasible when using the actual value. This may be beneficial in that over an interval where an object is moving at higher velocities (e.g., such as on a highway), resolution may be lower (e.g., a resolution of 60 m at 120 km/h or 33.3 meters per second) and still present full information value, while at lower speed, high resolution (yet within acceptable limits) (e.g., 34 m at 40 km/h or 17 m at 10 km/h). In some implementations, the codec 140 may be set to increase the overall bit width by the user if desired so as to further achieve higher resolution values, where accuracy may take priority over the need to minimize payload.

### Reducing the Bit Width of an Interval Using Small Delta

In some implementations, compression may further be improved when the location deltas are consistent, such as when an object moves at a fairly constant speed and direction. In some implementations, instead of inserting a delta vector angle and distance from the previous location as the interval values, the compressor 146 may change to a different mode and insert the information describing only the variation from the change between the previous interval and that associated with the new mode. Accordingly, the codec 140 may evaluate the interval and make a determination if the location deltas are consistent. If it is determined from the evaluation that the location deltas are consistent, then the new code may change to a new mode. As an example, assuming that an interval describes a change of 20.5 km at 256° during a first interval and 21.2 km at 251° during a second interval, when the compressor 146 recognizes that the resulting integer values are small enough, the compressor 146 may use smaller bitwidth (e.g., small delta) to indicate+0.7 km and −5° as the difference in the interval vector (e.g., for intervals where only integer values are needed).

### Resolution v. Distance and Angle Using Fixed Bit Width Integer Values

In some implementations, if the compressor 146 selects a 10-bit number to represent an interval distance in geographic degrees (e.g., 1023=0.3 degrees), an average resolution of about 30 m (30 km/1024) may be provided. As described above, the square root of the distance may be the actual integer value used (or the difference of the square roots of the distances for a small delta interval). This may provide a resolution of about 60 m when an object's (e.g., a vehicle) average velocity is 120 km/h at the high end and zero meters at zero speed, and about 30 m at 40 km/h. When the square root value is considered, the value may be scaled so that 1023=√0.3 is equal to 0.5477 (in square root degrees).

In some implementations, to utilize the angle as an integer, it may be scaled to a 12-bit number where 4095=360 degrees. This may divide each degree into 11.4 steps (4096/360), where each step may be 0.088 degrees or 0.0015 radians. At a radius of 30 km (e.g., 120 km/h over a 15-minute interval), this may provide a resolution of 45 meters (e.g., 30000×0.0015). Since the compressor 146 may use a resolution of 60 meters at this velocity to determine an acceptable bitwidth, 12 bits may provide more resolution than that requested by the algorithm (where 11 bits may be imprecise for 90 meters). For example, if the resolution threshold being calculated by the compressor 146 is 30 meters at this interval velocity, then one more bit may be added to the chosen bitwidth.

### Reducing the Bit Width According to Interval Length

In some implementations, if the interval is 5 minutes rather 15 minutes, then the maximum radius of travel within the interval may be 10 km for a velocity of 120 km/h. In some implementations, the resolution may be 15 meters (10000×0.0015), which may be four times more precise than that required by the algorithm settings when the object's velocity is 120 km/h. Therefore, with a 5-minute interval, the bit width for the angle may be reduced by 2 bits to 10 bits. Similarly, the bit width for the distance may be reduced from 10 bits to 9 bits.

### Dealing with the Effects of Cumulative Resolution Over a Series of Intervals

When individual locations are converted into interval values, the resolution described between each may be within the tolerances set by the compressor 146. However, the cumulative effect of such conversions may increase in direct proportion to the number of locations being compressed. Thus, in some implementations, the compressor 146 may use a simple correction algorithm to ensure that the small incremental differences from individual lower resolution interval values do not result in cumulative errors. In some implementations, the compressor 146 may determine the compression mode and the integer value being used in each interval. Then, the compressor 146 may calculate the position or location that would have been calculated by the receiving codec when each vector is added to compute the resulting locations. This calculated location may then be used as the reference point for the second interval rather than the actual second location so as to ensure that each interval results in a calculated location as if the original location itself was sent.

### Fixed Time Interval

In some implementations, the protocol packet may include a header containing an initial position and a date followed by a number of intervals (where an interval may include a block of position data representing the movement or delta of the movement during an interval of time). In some implementations, the intervals may start at midnight on the date given and increase by a fixed time span. For example, the first interval may contain the movement from 12:00 AM to 12:15 AM, and the second interval may contain the movement or the difference in the movement from 12:15 AM to 12:30 AM with respect to the first interval. Whether the movement (delta) or difference in movement (small delta) is sent may depend on the format of the interval, which also may depend on whether the difference is small (e.g., when the speed and/or direction remain reasonably constant over the interval).

In some implementations, intervals may be recorded in different formats, where the bitwidth may range in size, for example, from 16 bits to 24 bits, or even 1 bit in cases where no delta occurred during the interval. In some implementations, each interval may be preceded by a format change bit. In some implementations, if the format change bit is 0, indicating that the format has not changed from a previous interval, then the new interval which follows may use the same format and bit width as the previous interval. In other implementations, the movement data for the interval may be preceded by a description of the new format. TABLE 2 and TABLE 3 illustrate examples of the foregoing implementations, where values in italics are optional depending on the interval (only occurring if the format has changed).

TABLE 2

| | | 16 bit Date | |
|---|---|---|---|
| Header | 32 bit Master Position | Stamp | Additional Bits |
| Interval 1 | 1 format change bit | 1-4 bit format | 16-24 bit movement |
| . . . | . . . | . . . | . . . |
| Interval n | 1 format change bit | 1-4 bit format | 16-24 bit movement |

TABLE 3

| Bits: | Format | Description |
|---|---|---|
| 1 | Toggle Format | If current mode is to send normal bitwidth, switch to sending small |
| | | bitwidth. If currently sending small, switch to normal. If currently sending |
| | | no movement, switch to normal. |
| 01 | Stop Report | Vehicle stopped during this interval, insert high resolution movement to |
| | | the stop position and number of minutes into current interval. See Stop |
| | | report note below. |
| 001 | Extended Stop | An Extended Stop is a 5 bit number of intervals plus 10. A stop of nine |
| | | intervals or less is sent as a single 0 bit for each interval stopped. |
| 000x | Other change in | Additional bits replace xx to describe other possible changes in format |
| | format | such as reducing the normal bit width for periods of slower driving, |
| | | changing the interval length, or possible vehicle related events that may |
| | | occur between intervals. |

In some implementations, if the change bit is “1”, indicating a change in format, then the new format mode may be determined, for example, by counting the number of zeroes until the next “1”. In some implementations, toggle format may be used as the default format change, which may use the least amount of zeroes (or no zeroes).

### Stop Report Format

A stop report may occur when an object (e.g., a vehicle) stops for more than a few minutes (or other configurable number). In some implementations, a format of “01” may be inserted (e.g., 101 including the change bit). This may be followed by, for example, a 4-bit number of minutes for the start time of the stop report. The compressor 146 may insert the position as a distance and angle using, for example, 3 additional bits of accuracy than would be used during an interval where the object was traveling to provide an accurate stop position.

In some implementations, if the stop continues for more than one interval, the compressor 146 may insert, for example, another zero for each interval until the object starts moving again. When motion begins, the compressor 146 may insert, for example, a “1” followed by a 4-bit duration in minutes to define the stop time.

In other implementations, if the stop is less than one interval long in duration, then the duration may be the duration of the stop. If the stop is more than one interval, then the duration may be the additional minutes beyond the full interval. This also may be applied to the first start of motion of the day. For example, if there is a stop for two hours and two minutes, then eight zeros for the eight full intervals and a duration of two additional minutes may result. In this example, after the 4-bit duration, there may be no format change bit, and that the next format may follow directly after the 4-bit duration (e.g., where “1” is used if there is a normal interval of motion or “01” is used if there is another stop report).

### Illustrative Example

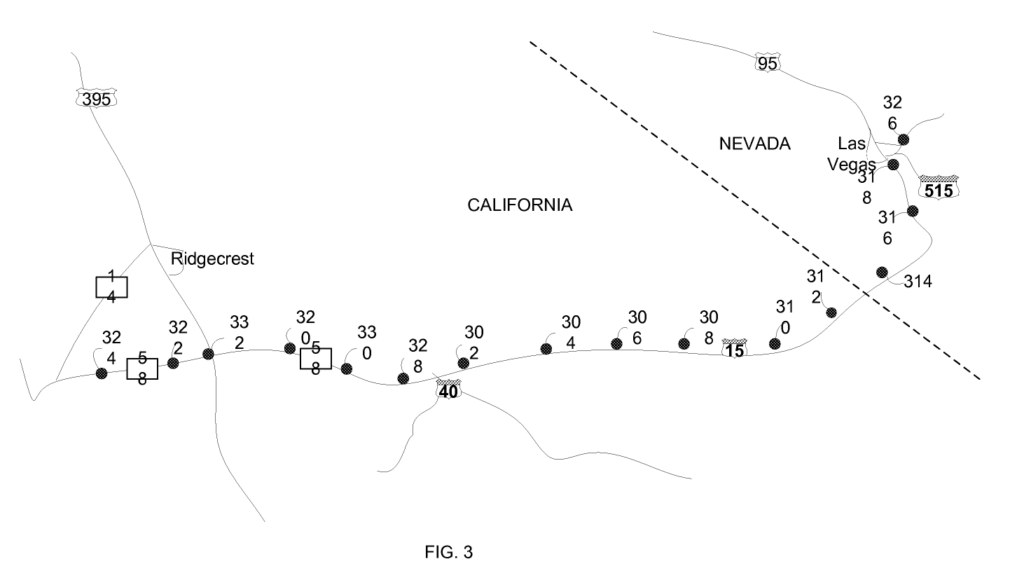

FIG. 3 shows an interstate highway connecting Las Vegas and Los Angeles. Locations 302-324 on the highway represent a vehicle traveling at a variable speed near 100 km/h. Using the pixel positions on the map, the latitude and longitude may be calculated for each point. An analysis being referred to herein below may provide one example illustrating how the locations according to this protocol may be sent, and how the error correction may be performed to ensure that the final results of adding all the intervals will provide a position within, for example, a 60-meter resolution threshold of the codec 140. The analysis as will be discussed below is merely illustrative and not limiting, and that other values or analytical methods also are contemplated.

### Example Analysis

As shown in FIG. 3, a vehicle may start at point 326, which is Las Vegas. The vehicle may leave Las Vegas at 8:10 AM and the first interval may end at 8:25 AM. Locations 302-324 along the highway may indicate the positions of the vehicle at each 15 minute interval. Locations 328-332 may indicate stops of 2 minutes or more.

Based on locations 302-324, the route may be encoded as shown in TABLE 4:

TABLE 4

| time | X (pix) | Y (pix) | Latitude | Longitude | dLat | dLong | Distance | Angle | Root Distance |
|---|---|---|---|---|---|---|---|---|---|
| 0:00 | 744 | 187 | 36.14583333 | −115.1677778 | 0 | 0 | 0 | | 0 |
| 8:25 | 731 | 265 | 35.89489376 | −115.209601 | −0.25093957 | −0.0338808 | 0.2532165 | 262.31067 | 0.50320618 |
| 8:40 | 693 | 334 | 35.67290875 | −115.3318536 | −0.22189648 | −0.0993861 | 0.2431371 | 245.87269 | 0.49308932 |
| 8:55 | 663 | 398 | 35.46700962 | −115.4283689 | −0.20584948 | −0.0786657 | 0.2203686 | 249.08556 | 0.4694343 |
| 9:10 | 592 | 419 | 35.39944896 | −115.6567882 | −0.06749865 | −0.1860423 | 0.1979086 | 199.94145 | 0.44486916 |
| 9:25 | 517 | 465 | 35.25145896 | −115.8980763 | −0.14806869 | −0.1969615 | 0.2464106 | 216.93454 | 0.49639763 |
| 9:40 | 460 | 515 | 35.09060026 | −116.0814552 | −0.16079137 | −0.1501919 | 0.2200261 | 226.9521 | 0.46906936 |
| 9:55 | 383 | 550 | 34.97799917 | −116.3291776 | −0.1125399 | −0.2031138 | 0.2322078 | 208.98966 | 0.48187941 |
| 10:10 | 302 | 572 | 34.90722134 | −116.5897687 | −0.07086368 | −0.2136712 | 0.2251156 | 198.34801 | 0.4744635 |
| 10:20 | 274 | 571 | 34.91043851 | −116.6798496 | 0.003121362 | −0.0739307 | 0.0739965 | 177.5824 | 0.27202303 |
| 10:28 | 243 | 586 | 34.8621809 | −116.7795819 | −0.048264 | −0.081834 | 0.0950064 | 210.53123 | 0.30823106 |
| 10:50 | 212 | 566 | 34.92652438 | −116.8793143 | 0.064326427 | −0.0817826 | 0.1040494 | 141.81303 | 0.3225669 |
| 11:01 | 149 | 546 | 34.99086786 | −117.0819963 | 0.064428185 | −0.1661852 | 0.1782373 | 158.80924 | 0.42218154 |
| 13:18 | 140 | 545 | 34.99408504 | −117.1109509 | 0.003217216 | −0.0236943 | 0.0239117 | 172.26767 | 0.15463424 |
| 13:33 | 59 | 539 | 35.01338808 | −117.371542 | 0.019315509 | −0.2133963 | 0.2142687 | 174.82798 | 0.46289165 |

As shown in TABLE 4, the latitude and longitude may be calculated from each location by scaling the x pixels by 0.004064 degrees per pixel and the y pixels by 0.003217 degrees per pixel. “dLat” and “dLong” may represent changes in latitude and longitude. The distance may be represented by the magnitude of dLat+dLong (square root of the sum of the squares). The angle may be represented by the inverse tangent of dLat/dLong. If “dLong” is negative, it may add 180 degrees to the angle. RootDistance may be represented by the square root of distance.

In TABLE 4, where the time is 8:25 AM, the “dLat” and “dLong” may be determined by subtracting the previous latitude and longitude from the current latitude and longitude (i.e., subtract row 1 from row 2). The subtraction takes little changes to account for the small errors that may be introduced by converting floating point numbers to integers. Thus, the compressor 146 may then take the latitude and longitude already converted to integer values back to floating point to calculate each “dLat and dLong” thereafter. TABLE 5 shows the results of such reverse conversion which may be fed back into TABLE 4 to further enhance the accuracy of the resulting calculations.

TABLE 5

| time | iDistance | iAngle | aDistance | aAngle | adLong | adLat | aLongitude | aLatitude |
|---|---|---|---|---|---|---|---|---|
| 0:00 | | | | | −115.167778 | 36.145833 | −115.16778 | 36.145833 |
| 8:25 | 940 | 2984 | 0.253294462 | 262.3296703 | −0.0417334 | −0.2510281 | −115.20951 | 35.894805 |
| 8:40 | 921 | 2797 | 0.243158384 | 245.8901099 | −0.12227013 | −0.2219461 | −115.33178 | 35.672859 |
| 8:55 | 877 | 2833 | 0.220479987 | 249.0549451 | −0.09677151 | −0.2059115 | −115.42855 | 35.466948 |
| 9:10 | 831 | 2274 | 0.197957534 | 199.9120879 | −0.22833429 | −0.06742 | −115.65689 | 35.399528 |
| 9:25 | 927 | 2468 | 0.246336891 | 216.967033 | −0.24101418 | −0.148136 | −115.8979 | 35.251392 |
| 9:40 | 876 | 2582 | 0.219977468 | 226.989011 | −0.18338676 | −0.1608526 | −116.08129 | 35.090539 |
| 9:55 | 900 | 2377 | 0.232196146 | 208.967033 | −0.24793135 | −0.1124541 | −116.32922 | 34.978085 |
| 10:10 | 886 | 2256 | 0.225028451 | 198.3296703 | −0.26047604 | −0.0707679 | −116.5897 | 34.907317 |
| 10:20 | 4068 | 16163 | 0.073996178 | 177.5774407 | −0.09015336 | 0.0031277 | −116.67985 | 34.910445 |
| 10:28 | 4609 | 19162 | 0.094986267 | 210.5264443 | −0.09971694 | −0.0482469 | −116.77957 | 34.862198 |
| 10:50 | 602 | 1613 | 0.103887422 | 141.8021978 | −0.0995785 | 0.0642417 | −116.87914 | 34.92644 |
| 11:01 | 6314 | 14455 | 0.17826109 | 158.8122196 | −0.20288328 | 0.0644281 | −117.08203 | 34.990868 |
| 13:18 | 289 | 1960 | 0.023942289 | 172.3076923 | −0.02896303 | 0.0032048 | −117.11099 | 34.994073 |
| 13:33 | 865 | 1989 | 0.214487606 | 174.8571429 | −0.26082961 | 0.0192265 | −117.37182 | 35.013299 |

TABLE 5 shows the conversion to 10-bit integer distance and 12-bit angle. The maximum range for the square root of the distance is 0.548. These values may be rounded to the nearest integer (up or down) to provide iDistance and iAngle, as may be given by [1] and [2]:

iDistance=rootDistance*1023/0.548 [1]

iAngle=Angle*4095/360 [2]

The next two columns, “aDistance” and “aAngle”, show the result of the reverse operation where the integer values are converted back to floating point values. The results under the “aDistance” column may be squared so that real distance instead of the square root distance may be provided. That is, the results under “aDistance” and “aAngle” may be approximate distance and angle because the results have lost a certain accuracy in the conversion process (e.g., accurate to ˜30 meters depending on the speed), which may be given by [3] and [4]:

aDistance=(iDistance*0.548/1023)² [3]

aAngle=(iAngle*360/4095)² [4]

The difference in longitude (adLong) and latitude (adLat) in TABLE 5 may be approximate and calculated using the approximate distance “aDistance” and angle “aAngle”. However, since “dLong” is a normalized longitude, and adLong is still a normalized longitude, the approximate distance “aDistance” may be divided by the cosine of the latitude for the corresponding interval so that the longitude may be in real degrees, which then may be fed back and compared with the actual longitude, as may be given by [5] and [6]:

adLong=aDistance*cos(aAngle)/cos(Latitude) [5]

adLat=aDistance*sin(aAngle) [6]

The new approximate latitude “aLatitude” and longitude “aLongitude” may be calculated by adding previous values of “adLong” and “adLat”. These new values, “aLatitude” and “alongitude” may be fed back into the calculation of “dLat” and “dLong” in the TABLE 4 for every row after the second row (i.e., after 8:25 AM). For example, “dLat” in the 3^{rd} row (i.e., 8:40 AM) may be provided by subtracting “aLatitude” from the 2^{nd} row shown in TABLE 5 from the “Latitude” in the 3^{rd} row of TABLE 4 (i.e., “dLat” in the 3^{rd} row=“Latitude” in the 3^{rd} row−“aLatitude” from the 2^{nd} row of TABLE 5), where “dLong” may be normalized each time. As an example, dLat_{8:40}=Latitude_{8:40}−aLatitude_{8:25}, and dLong_{8:40}=(Longitude_{8:40}−aLongitude_{8:25})Cos(Latitude_{8:40}).

Once “dLat” and “dLong” are calculated in the 3^{rd} row of TABLE 4, the compressor 146 may determine the rest of the 3^{rd} row in TABLE 4 and then the 3^{rd} row in TABLE 5.

TABLE 6 shows the resulting errors. In each row, the error may be given by [7] and [8]:

errLat=Latitude−aLatitude [7]

errLong=Longitude−aLongitude [8]

The latitude error “errLat” and longitude error “errLong” may be both errors in degrees. TABLE 6 also shows the errors converted to meters, as may be given by [9] and [10]:

errLatM=errLat*30000/0.294 [9]

errLongM=errLong*3000/0.294*Cos(Latitude) [10]

TABLE 6

| Latitude | Longitude | aLatitude | aLongitude | errLat | errLong | errLatM | errLongM |
|---|---|---|---|---|---|---|---|
| 36.145833 | −115.167778 | 36.14583333 | −115.167778 | 0 | 0 | 0 | 0 |
| 35.894894 | −115.209601 | 35.89480523 | −115.209511 | −8.8525E−05 | 8.98656E−05 | −9.03319849 | 7.4285271 |
| 35.672909 | −115.331854 | 35.67285909 | −115.331781 | −4.966E−05 | 7.2343E−05 | −5.067375327 | 5.9967849 |
| 35.46701 | −115.428369 | 35.46694762 | −115.428553 | −6.2001E−05 | −0.00018395 | −6.326618684 | −15.287494 |
| 35.399449 | −115.656788 | 35.39952765 | −115.656887 | 7.86882E−05 | −9.8886E−05 | 8.029409939 | −8.2250187 |
| 35.251459 | −115.898076 | 35.25139163 | −115.897901 | −6.7328E−05 | 0.00017498 | −6.870182955 | 14.580964 |
| 35.0906 | −116.081455 | 35.09053907 | −116.081288 | −6.1187E−05 | 0.000167135 | −6.243549328 | 13.954798 |
| 34.977999 | −116.329178 | 34.97808502 | −116.329219 | 8.58474E−05 | −4.1817E−05 | 8.759943672 | −3.4962682 |
| 34.907221 | −116.589769 | 34.90731715 | −116.589695 | 9.58125E−05 | 7.32389E−05 | 9.776782605 | 6.1287494 |
| *34.910439 | −116.67985 | 34.9104449 | −116.679849 | 6.38581E−06 | 7.54868E−07 | 0.651613619 | 0.0631661 |
| *34.862181 | −116.779582 | 34.86219796 | −116.779566 | 1.70528E−05 | 1.62065E−05 | 1.740083362 | 1.3569285 |
| 34.926524 | −116.879314 | 34.92643968 | −116.879144 | −8.4705E−05 | 0.000170099 | −8.643352433 | 14.230789 |
| *34.990868 | −117.081996 | 34.99086782 | −117.082028 | −4.1506E−08 | −3.1222E−05 | −0.004235336 | −2.6100807 |
| 34.994085 | −117.110951 | 34.99407257 | −117.110991 | −1.2465E−05 | −3.9682E−05 | −1.271933316 | −3.3171772 |
| 35.013388 | −117.371542 | 35.01329909 | −117.37182 | −8.8988E−05 | −0.0002782 | −9.080424576 | −23.249701 |

As shown in TABLE 6, the errors “errLatM” and “errLongM” (in meters) demonstrate that the transmitted integer values may result in errors of under the, for example, 30 m average resolution that is required. During stop reports, the locations may be accurate to under, for example, 3 m. It is also important that the acceptable fluctuations do not develop into larger errors as the interval increases. In the second to last interval, there is also a small error because the vehicle did not move very far or very fast during that interval, and resolution may be dependent on speed.

TABLE 7 lists the differences for the integer distance and angle to determine if the difference is small to be sent instead of the actual distance and angle. TABLE 7 assumes that if the absolute difference in distance “|diffDistance|” is <128 and the absolute difference in angle “|diffAngle|” is <256, then the differences may be sent instead of the full values.

TABLE 7

| iDistance | iAngle | diffDistance | diffAngle | smallDist | small Angle |
|---|---|---|---|---|---|
| 0 | 0 | | | TRUE | TRUE |
| 940 | 2984 | 940 | 2984 | FALSE | FALSE |
| 921 | 2797 | −19 | −187 | TRUE | TRUE |
| 877 | 2833 | −44 | 36 | TRUE | TRUE |
| 831 | 2274 | −46 | −559 | TRUE | FALSE |
| 927 | 2468 | 96 | 194 | TRUE | TRUE |
| 876 | 2582 | −51 | 114 | TRUE | TRUE |
| 900 | 2377 | 24 | −205 | TRUE | TRUE |
| 886 | 2256 | −14 | −121 | TRUE | TRUE |
| 4068 | 16163 | 3182 | 13907 | FALSE | FALSE |
| 4609 | 19162 | 541 | 2999 | TRUE | FALSE |
| 602 | 1613 | −4007 | −17549 | FALSE | FALSE |
| 6314 | 14455 | 5712 | 12842 | FALSE | FALSE |
| 289 | 1960 | −6025 | −12495 | FALSE | FALSE |
| 865 | 1989 | 576 | 29 | FALSE | TRUE |

### Stop Reports

The calculations as described above may continue until the timestamp reaches 10:20 AM. At 10:20 AM, (which is location 328 on the route), the vehicle stops for 5 minutes. This results in a stop report that causes a higher than normal resolution distance and angle to be inserted to provide a more precise location. In this example, stop reports may be eight times more accurate in precision, which adds three bits each to the distance and angle. The “iDistance” and “iAngle” thus may be calculated, as may be given by [11] and [12]:

iDistance=rootDistance*8191/0.548 [11]

iAngle=Angle*32767/360 [12]

TABLE 8 shows the stop report schedule corresponding to locations 328-332 shown in FIG. 3:

TABLE 8

| Stop # | Time | Latitude | Longitude |
|---|---|---|---|
| 1 | 10:20 to 10:25 | 34.91043851 | −116.6798496 |
| 2 | 10:28 to 10:35 | 34.8621809 | −116.7795819 |
| 3 | 11:01 to 13:03 | 34.99086786 | −117.0819963 |

The first stop event ends at 10:25 AM, so the next 15 minute interval would run from 10:25 AM to 10:40 AM, but before that interval is complete, there is another stop at 10:28 AM for 7 minutes, which sets the beginning of the next interval ahead to 10:35 AM. As such, the next normal interval runs from 10:35 AM to 10:50 AM. Thereafter, there is a stop at 11:01 AM for 2 hours 3 minutes. The next normal interval begins at 13:03 PM and ends at 13:18 PM. The vehicle continues along its route and comes to a final stop before the end of the day.

In some implementations, when motion begins after a stop event, a start event may be recorded. In some implementations, the compressor 146 may record this event as a “1” followed by a 4-bit number of minutes. The number of minutes may be the duration (d) of the stop beyond the number of intervals of the stop. For example, if the stop is for 70 minutes (i.e., 4×15 minute intervals plus 10 minutes), then the duration “d” would be 10.

The compressor 146 may calculate from the collected data to form a packet with respect to this route. First, there is a period of 32 intervals with no motion. In one implementation, the first period may be represented by using the extended stop format flag (001) followed by the value “22” (e.g., as 10110 binary, which is 32-10 as described in the format flags section). If the vehicle's motion begins at 8:10 AM, the packet may have the header followed by the extended stop (00110110), which is followed by “11010” (e.g., start event where the duration “d” is 10 minutes), which are followed by the values “942” and “2964”, which is followed by “11” to change format to differences. This is followed by the differences, full values and stop reports as detailed in TABLE 9.

To construct the packet to represent this route, TABLE 9 lists the header in the top two pairs of rows, followed by the position interval data. In some implementations, the header may be formatted as hexadecimal, but the following data also may be formatted as binary so that the divisions between intervals can be seen.

To construct the packet, the following paradigm may be used:

D and A=normal distance and angle

dD and dA=small difference in distance and angle

hD and hA=high res distance and angle for stop reports

t=time of stop (minutes into interval)

d=duration of stop (minutes)

In some implementations, an “order byte” may be added to the header. The first five bits may provide the packet number for the day (e.g., first packet may be zero), while the last 3 bits may specify the number of bits used in the last byte of the packet. In some implementations, the master latitude and longitude may be multiplied by 6000000 and converted to Hex Date (e.g., 5 bits Day+4 Bits Month+7 Bits 2 digit Year would convert the date “Oct. 9, 2005” to “4D05”).

TABLE 9

| Cmd Code\|Order Byte | Date | Master Latitude (36.145833) | Master Longitude (−115.16778) |
|---|---|---|---|
| 1F\|00000011 (x03) | 4D05 | 0CED3FF6 | D6D01328 |

Options: 5 bits unused + Interval length 15 (0 = 5, 1 = 15, 2 = 30, 3 = 60) + Stop reports 1 (0n)

| 00000 01 1 (x03) | | | |
|---|---|---|---|
| Extended stop report | 22 + 10 intervals | Start d = 10 D = 940 (8:25) | A = 2984 |
| 001 | 10110 | 1 1010 1110101100 | 101110101000 |
| New Format dD = −19 (8:40) | dA = −187 | Same Format dD = −44 (8:55) | dA = 36 |
| 11 11101101 | 101000101 | 0 11010100 | 000100100 |
| New Format D = 831 (9:10) | A = 2274 | New Format dD = 96 (9:25) | dA = 194 |
| 11 1100111111 | 100011100010 | 11 01100000 | 011000010 |
| Same Format dD = −51 (9:40) | dA = 114 | Same Format dD = 24 (9:55) | dA = −205 |
| 0 11001101 | 001110010 | 0 00011000 | 100110011 |
| Same Format dD = −14 (10:10) | dA = −121 | Stop Rpt t = 10 min hD = 4068 (10:20) | hA = 16163 |
| 0 11110010 | 110000111 | 101 1010 0111111100100 | 011111100100011 |
| Start d = 5 min, Stop t = 3 min | hA = 19162 | Start d = 7 min normal interval D = 602 | A = 1613 |
| hD = 4609 (stop @ 10:28) | | (10:50) | |
| 1 0101 01 0011 1001000000001 | 100101011011010 | 1 0111 1001011010 | 011001001101 |
| Stop Rpt t = 11 min hD = 6314 | hA = 14455 | Stopped for 8 intervals | A = 1960 |
| (11:01) | | Start d = 3 min, D = 289 (13:18) | |
| 101 1011 1100010101010 | 011100001110111 | 00000000 1 0011 0100100001 | 011110101000 |
| Same Format D = 865 (13:33) | A = 1989 | | |
| 0 1101100001 | 011111000101 | | |

In this example, the binary position interval data may be arranged in binary octets so as to be converted to hexadecimal pairs. For example, the binary octets:

00110110 10000111 01011001 01110101 00011111 01101101 00010101 10101000 00100100 11110011 11111000 11100010 11011000 00011000 01001100 11010011 10010000 01100010 01100110 11110010 11000011 11010101 01111111 00100011 11110010 00111011 01000111 00100000 00011001 01011011 01010111 10010110 10011001 00110110 11011110 00101010 10011100 00111011 10000000 01001101 00100001 01111010 10000110 11000010 11111000 101xxxxx

may be converted to:

### 36 D7 59 75 1F 6D 15 A8 24

### F3 F8 E2 D8 18 4C D3 90 62

### 66 F2 C3 D5 7F 23 F2 3B 47

### 20 19 5B 57 96 99 36 DE 2A

### 9C 3B 80 4D 21 7A 86 C2F8

### A0

The complete packet, with header and data arranged in 2-byte hex quartets may be given by:

### 1F03 4D05 0CED 3FF6 D6D0 1328 0336 D759 751F 6D15 A824 F3F8 E2D8 184C D390 6266 F2C3 D57F 23F2 3B47 1129 5B57 9699 36DE 2A9C 3B80 4D21 7A86 C2F8 A0

### Comparison of Packet Size

In one example, the total length of a packet may be 59 bytes (e.g., 13 byte header+363 data bits+5 spare bits). The portion of the packet that represents the movement through the first nine intervals may be 196 bits (e.g., 21.7 bits per interval). This may represent normal data without stop events. The data portion of the packet may use 45 bytes starting from the beginning of the motion (e.g., while excluding the extended stop at the start). There may be 14 different positions listed, which averages out to 25.7 bits per position, but the time and position may be accurate with respect to three stops. The trip is five hours and twenty three minutes (22 intervals), which averages out to 16.3 bits per interval over the period described above.

### Using Bigger or Smaller Intervals

In some implementations, the bit widths of certain fields may change if the compressor 146 uses longer or shorter intervals as shown in TABLE 10. In some implementations, the interval lengths may include, without limitations, five, fifteen, thirty or sixty minutes.

TABLE 10

| | Normal Distance | Normal Angle | | | |
|---|---|---|---|---|---|
| Interval | (differences are | (differences are 3 | Small Distance | Small Angle | Stop Report time |
| Length | less) | less) | threshold | threshold | and duration |
| 5 | 9 | 10 | 64 | 64 | 3 |
| 15 | 10 | 12 | 128 | 256 | 4 |
| 30 | 11 | 13 | 256 | 512 | 5 |
| 60 | 12 | 14 | 512 | 1024 | 6 |

### Sending Routes More than Once a Day

In some implementations, an up-to-date route of an object may further be enhanced by sending a packet in chunks as the day progresses and combining each chuck back together by the receiving decompressor. In some implementations, one packet may be sent out after the first motion of the day, followed by a new packet each time a predetermined number hours (or minutes) have elapsed.

In some implementations, the protocol header may be sent only in the first packet, and each packet sent after that may contain a command code byte of (e.g., 1F) and an additional sequence byte to give the order of such a packet among the packets for the day. The order byte also may specify the number of bits used in the last byte, so that any unused bit(s) may be ignored when reassembling the packets.

For example, using the example given in FIG. 3, to send the same route on a hourly basis, the following format may be used:

1^{st} packet (sent at 8:10):
header: 1F05 2EFDC042 19DA7FEC 7F4104000F8C ext stop report: 36
start report: binary 1 1010 xxx (xD0)
Complete packet: 1F05 4D05 0CED 3FF6 D6D0 1328 0336 D0 (15 bytes)
2^{nd} packet (sent at 9:10):
header: 1F 0B (00001 011)
binary data: 1110101100 101110101000 (8:25) 1111101101 101000101 (8:40) 0 11010100 000100100 (8:55) 11 1100111111 100011100010 (9:10)
octets: 11101011 00101110 10100011 11101101 10100010 10110101 00000100 10011110 01111111 00011100 010xxxxx (EB2E A3ED A2B5 049E 7F1C 40)
Complete packet: 1F0B EB2E A3ED A2B5 049E 7F1C 40 (13 bytes)
3^{rd} packet (sent at 10:10):
header: 1F 11(00010 001)
binary data: 11 01100000 011000010 (9:25) 0 11001101 001110010 (9:40) 0 00011000 100110011 (9:55) 0 11110010 110000111 (10:10)
octets: 11011000 00011000 01001100 11010011 10010000 01100010 01100110 11110010 11000011 1xxxxxxx (D818 4CD3 9062 66F2 C380)
Complete packet: 1F17 D818 4CD3 9062 66F2 C380 (12 bytes)
4^{th} packet (sent at 11:10):
header: 1F1A (00011 010)
binary data: 101 10100111111100100 011111100100011 (10:20) 1 0101 01 0011 1001000000001 100101011011010 (10:28) 1 0111 1001011010 011001001101 (10:50) 101 1011 1100010101010 011100001110111 (11:01)
octets: 10110100 1111111001000111 11100100 01110101 01001110 01000000 00110010 10110110 10101111 00101101 00110010 01101101 10111100 01010101 00111000011 1011 (B4FE 47E4 754E 4032 B6AF 2D32 6DBC 5538 77)
Complete packet: 1F1A B4FE 47E4 754E 4032 B6AF 2D32 6 DBC 5538 77 (19 bytes)
5^{th} packet (sent at 13:03):
header: 1F 25 (00100 101)
binary data: 00000000 (stopped 8 intervals) 1 0011 (start d=3) octets: 00000000 1001 1xxx (0098)
Complete packet: 1F25 0098 (4 bytes)

The total size of the individual packets sent once an hour may be 71 bytes. The original packet sent in one transmission may be 59 bytes. The difference may be contributed by the fact that there were five additional 2-byte headers, plus a few end bits wasted on each additional packet. In some implementations, such end bits may be four bits.

### Optional Stop Reports

In some implementations, to save bytes, stop reports may be turned off. This may cause positions to be recorded on even 15 minute boundaries (or 5 min etc.). In some implementations, when there is an interval with no motion, there may be a format change to a stop report (101) followed by one zero for each interval stopped. If the motion stops for more than nine intervals, an extended stop (1001) may be recorded instead. In some implementations, there may be no stop time (t), duration (d) or high resolution distance and angle recorded. In other implementations, any interval where there is motion may be recorded as a normal distance and angle or as a small difference according to the normal rules.

Again, using the example shown in FIG. 3, since motion began at 8:10 AM, the first interval would have been from 8:00 AM to 8:15 AM. When the vehicle stopped from 10:20 AM to 10:25 AM, that would have been ignored, but the interval from 10:15 AM to 10:30 AM would naturally have a lower distance because it was stopped for part of the time. The stop from 10:28 AM to 10:35 AM would also be ignored, with a smaller distance traveled in the interval from 10:30 AM to 10:45 AM. TABLE 11 shows an estimate of the bit widths for each interval if stop reports are turned off. Because of the starting and stopping after 10:20 AM, it is assumed those intervals will not be smooth enough to make any differences.

TABLE 11

| Time | | Bit width |
|---|---|---|
| 8:15 | Normal D + A | 2 + 10 + 12 = 24 |
| 8:30 | Differences dD + dA | 2 + 8 + 9 = 19 |
| 8:45 | Differences dD + dA | 1 + 8 + 9 = 18 |
| 9:00 | Normal D + A | 2 + 10 + 12 = 24 |
| 9:15 | Differences dD + dA | 2 + 8 + 9 = 19 |
| 9:30 | Differences dD + dA | 1 + 8 + 9 = 18 |
| 9:45 | Differences dD + dA | 1 + 8 + 9 = 18 |
| 10:00 | Differences dD + dA | 1 + 8 + 9 = 18 |
| 10:15 | Differences dD + dA | 1 + 8 + 9 = 18 |
| 10:30 | Normal D + A | 2 + 10 + 12 = 24 |
| 10:45 | Normal D + A | 1 + 10 + 12 = 23 |
| 11:00 | Normal D + A | 1 + 10 + 12 = 23 |
| 11:15 | Normal D + A | 1 + 10 + 12 = 23 |
| . . . | Stopped 7 intervals | 3 + 7 = 10 |
| 13:15 | Normal D + A | 2 + 10 + 12 = 24 |
| 13:30 | Normal D + A | 1 + 10 + 12 = 23 |

TABLE 11 covers a time of five hour and thirty minutes or twenty-two intervals, using a total of 326 bits for an average of 14.8 bits per interval, or 21.0 bits for the fifteen intervals in which there was motion.

### Fixed Distance Interval Alternative

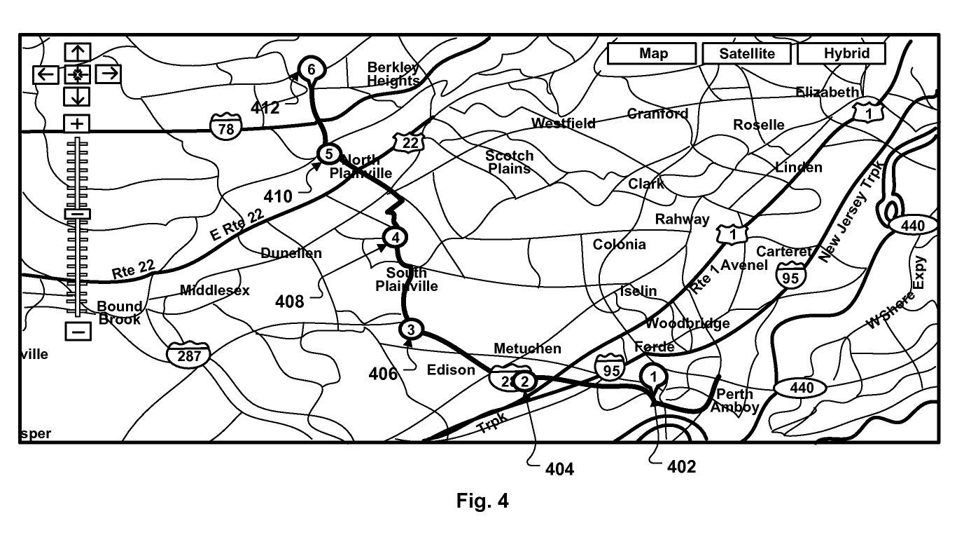

In some implementations, a fixed distance interval compression process may be used. In some implementations, the compressor 146 may use most of the same rules as the fixed time interval process described above, except that each interval may be a fixed distance instead of a fixed time. In this process, the codec 140 may use a predetermined distance (e.g., 5 km) for each interval rather than a time threshold. The compressor 146 may decide about when to record a new location when movement (equal to the distance settings) has occurred, and then place the angle and time in the interval rather than angle and distance. In some implementations, only the angle need be accurate in order to provide a precise location. Assuming time to the minute is an approximation and the time range may be represented in, for example, fifteen minutes, then time may require only four bits, rather than the eight to twelve bits used in the fixed time interval calculations, which may save four to eight bits per interval. In applications where a user can benefit from having an evenly spaced plot of the route, fixed distance interval compression may be selected to provide location information which may be viewed on a mapping application. FIG. 4 shows an example of such a route with an evenly spaced plot.

In some implementations, the fixed interval compression process may be modified adaptively so that the compressor 146 may change the distance interval as needed to provide more detail where needed. Many routes may include a variety of driving conditions, such as making stops within a city, where the adaptive algorithm may switch from, for example, 5 km to a smaller distance interval such as 1 km or 100 meters, to provide a level of detail appropriate for that portion of an overall route. At higher velocities such as the highway portion of an overall route, the adaptive algorithm may switch to a larger distance interval and resolution where position accuracy may be fairly academic at higher velocities.

In some implementations, the adaptive process for selecting and switching the distances used for intervals according to variations in average velocity may impose additional parsing rules. The basic non-adaptive interval process may follows thereafter. This technique may apply to a mobile device with the codec 140 embedded that may compress available data points provided via a GPS receiver.

Referring to FIG. 4, the latitude and longitude coordinates of the 1^{st} four points 402-408 as shown may be given as:

Location 402→40.516967,−74.307114(0.7071544,−1.2969038)

Location 404→40.528270,−74.364364(0.70735175,−1.2979030)

Location 406→40.553565,−74.420910

Location 408→40.636881,−74.451008

In the route packet header (as in the fixed time interval), the compressor 146 may use a high resolution absolute location for location 402. In some implementations, in the options byte of the header, the fixed distance of subsequent intervals may be described. In the example shown, two bits may be used to describe one of four available choices: binary 00=100 meters, 01=1 km, 10=5 km, 11=20 km. For illustrative purposes, FIG. 4 describes four locations along a route where the average velocity may cause the adaptive algorithm to use 5 km spacing between the intervals.

By monitoring the GPS and determining when the vehicle is 5 km away from location 402, the compressor 146 may use “lat”/“long” to determine the angle from location 402 to location 404 and send the whole number of minutes that have elapsed for processing. The angle plus implied distance may define a distance vector, which may be visualized as a line 5 km long with a predetermined angle. To calculate the distance in km for the GPS “lat” and “long”, equation [13] may be used:

$$distance = 2 E {sin}^{- 1} \sqrt{cos {Lat}_{a} cos {Lat}_{b} {sin}^{2} ( ( {Lon}_{a} - {Lon}_{b} ) / 2 ) + \\ {sin}^{2} ( ( {Lat}_{a} - {Lat}_{b} ) / 2 )} \qquad [ 13 ]$$

where E may be the Earth's radius, and where angles may be in radians.

In some implementations, the angle may be sent as an integer, as in the example associated with the time interval given above, and the number of bits used may depend on the desired accuracy. The compressor 146 may choose an accuracy of +/−16 meters for 5-km intervals, where higher resolution may not be required for tracking at these moderately high speeds. With a circle of 5 km radius, the circumference may be 31,415 meters. Using an accuracy of +/−16 meters, 31415 m/32 m=981. Therefore, a 10-bit integer may be used to describe the interval angle since 2¹⁰=1024. From location 402 to location 404, the angle may be given by equation [14]:

$${tan}^{- 1} \frac{40.528270 - 40.516967}{- 74.307114 -- 74.364364} = {tan}^{- 1} - 0.1974323 = {168.8315963}^{°} \qquad [ 14 ]$$

This may be converted (by ratio) to a 10-bit integer (0-1023), where the resulting angle may be equal to 168.8315963*1023/360 or 491.018, which may be rounded to about 491.

It should be noted that an error is produced when using 491 as the angle instead of 491.018. In this example, the compressor 146 may choose 10 bits to represent the angle value, which may yield an acceptable accuracy of +/−16 meters for the average velocity of the interval. To prevent these “acceptable” resolution tolerances from accumulating over incremental intervals, (i.e., 16 m+16 m+16 m=+/−48 m) in some implementations, the compressor 146 may include an error correction process. In some implementations, instead of basing the next calculation, for example, on the actual position of location 404, the compressor 146 may base the calculation on the approximate position obtained by reversing the calculation so that both the compressor 146 and the decompressor 148 of the codec 140 may use the exact same reference location when evaluating position 3, as may be given by:

θₐₚₚᵣₒₓ=491*360/1023=168.825214 [15]

Now the compressor 146 may calculate the same approximate latitude and longitude for location 404 that also may be obtained by using the distance and angle. The fixed distance reference may be in km, and the latitude and longitude may be in degrees.

In some implementations, to achieve this conversion, an ellipse may be used where the height radius may be 5 km in latitude and the width radius may be 5 km in longitude. Then, a line may be drawn at a 168.825214 degree angle which may be used to calculate where the line intersects the ellipse. The length of the line (r) may be the distance in degrees, as may be given by [16]:

$$r = \frac{a \times b}{\sqrt{{a}^{2} {sin}^{2} θ + {b}^{2} {cos}^{2} θ}} = \frac{0.002659713}{\sqrt{0.0001314071 + 0.001946005}} = {0.05835438}^{°} \qquad [ 16 ]$$

where the approximate latitude may be given as [17]:

Lat₂ₐₚₚᵣₒₓ=Lat₁+r sin θ=40.516967°+0.01130923°=40.5282762° [17]

and where the approximate longitude may be given as [18]:

Long₂ₐₚₚᵣₒₓ=Long₁+r cos θ=−74.30714°−0.05724801°=−74.3643880° [18]

As shown, the result is different from the original values for location 404 (lat=40.528270, long=−74.364364). This may become the new starting point for going from location 404 to location 406 (which may be 40.553565, −74.420910). From location 404 to location 406, the angle may be given as [19]:

$${tan}^{- 1} \frac{40.553565 - 40.5282762}{- 74.420910 -- 74.364388} = {tan}^{- 1} ( - 0.44741516 ) = {155.895534}^{°} \qquad [ 19 ]$$

In some implementations, the angle given in [19] may be converted to a 10-bit integer so that the angle may be given as 155.895534963*1023/360=453.396˜453, where the approximate angle may be given as θₐₚₚᵣₒₓ₂=453*360/1047=155.759312.

Optionally, at this point, one additional compression feature may be provided. Specifically, similar to the time interval compression process which uses a smaller difference in distance and angle when possible (small delta), it is also possible to send a small delta for this angle. As shown above, the angle 453 is not too different than the previous angle 491.

In some implementations, if the absolute value of the difference is less than ⅛ of the full range of 1048 (1048/8=128), then a difference of angle may be sent in eight bits rather than the full ten-bit angle. For example, using the example given above, the second interval from location 404 to location 406, the difference in angle may be given as −38(453-491), such that the compressor 146 may insert −38 as a signed value in eight bits and use binary 11011010 to describe the second angle.

In some implementations, at the start of this interval, a format change may be implemented to small angles by sending, for example, the two bits “11”. In some implementations, if the next interval is also a small angle, then the format change may be a single bit “0” because the format may stay the same. If the format changes back to 10-bit angles, then the next interval may begin with “11” to indicate a change again.

Using the ellipse equation given above for the new angle, the length of the line (r) may be given by [20]:

r=0.055820334 [20]

where the approximate latitude may be given by [21]:

Lat₃ₐₚₚᵣₒₓ=Lat₂+r sin θ=40.5282762°+0.02291819°=40.5511944° [21]

where the approximate longitude may be given by [22]:

Long₃ₐₚₚᵣₒₓ=Long₂+r cos θ=−74.364388°−0.05089859°=−74.41528660 [22]

This becomes the new starting point for going from location 406 to location 408 (which is 40.636881, −74.451008).

From location 406 to location 408, the angle may be given by [23] and [24]:

$$\begin{matrix}{tan}^{- 1} \frac{40.636881 - 40.551194}{- 74.451008 -- 74.4152866} = {tan}^{- 1} ( - 2.398758 ) = {112.630395}^{°} & [ 23 ] \\ angle = 112.630395 * 1047 / 306 = 327.566 ∼ 328 & [ 24 ]\end{matrix}$$

The difference between the angle (given by [24]) and the previous angle is −126 (328-453), which is under 128 so that the difference may be sent as a small interval and the format change may be given as ‘0’ this time. The latitude and longitude may then be given as (40.516967, −74.307114).

Putting this all together into a packet similar to the previously described time interval packet, the compressor 146 may produce a packet as shown below in TABLE 12:

TABLE 12

| | | Master Latitude | Master Longitude |
|---|---|---|---|
| Cmd Code\|Order Byte | Date | (40.516967) | (−74.307114) |
| 1F\|00000011 | 4D05 | 0E7D706A | E56CFB04 |
| (x03) | | | |

Options: 4 bits unused + 1 = distance intervals + Interval length 5 km
(0 = 0.1, 1 = 1, 2 = 5, 3 = 20) + Stop reports 1 (0n)

| 00001 10 1 (x0D) | | | |
|---|---|---|---|
| Extended stop report | 22 + 10 intervals | Start minutes = 10 (8:25) | A = 491 |
| 001 | 10110 | 1 1010 | 0111101011 |
| New Format minutes = 10 | dA = −38 | Same Format minutes = 12 | dA = −126 |
| 11 1010 | 11011010 | 0 1101 | 10000010 |

### Distance Interval Process with Adaptive Interval Lengths

While the example above describes one configuration of the codec 140 that includes a single fixed interval, an adaptive interval length solution also may be used to provide more detail at low speeds and less detail at high speeds. Consider a case in which a vehicle is driving slow for 5 km and then faster thereafter. Because the speed fluctuates, an average speed over several intervals may need to be examined before determining how and when to change the interval length. Assuming that 1 km intervals are used at the slower speed and 5 km intervals are used for the faster speed, one solution may include logging 1 km intervals for the entire trip and then deciding after 5 intervals to start discarding 4 out of every 5 intervals to give 5 km intervals. However, unless the vehicle is travelling in a straight line during the entire course, every 5^{th} interval may not be exactly 5 km apart because the vehicle keeps changing direction. This means that the interval selection may be determined in near real time while the vehicle is moving. In this example, a speed increase may first be detected after 5 km (e.g., by a detector of a mobile unit). 1 km intervals may continue to be logged in an event that 1 km intervals are to be used. After a few more kilometres, 1 km intervals may be switched to 5 km intervals immediately after the 5^{th} interval, such that beginning from 5 km away from the 5^{th} point, the distance may be monitored. This may be at the same time during which 1 km increments also are being monitored. When 5 km away from the 5^{th} point is reached, if the speed is still high enough, this point may be logged (while the 1 km points accumulated after the 5^{th} point may be ignored), and become the new reference point.

In some implementations, the compressor 146, in the packet data, may mark the change from 1 km to 5 km intervals with a special format change code. In some implementations, the compressor 146 may use “10001” to indicate the interval length change (recall that 1001 means extended stop, so 10001 is the next possible choice), which may be followed by the 2 bits used to indicate the new interval length (e.g., four choices, recalling that 5 km=“10” binary). Depending on the interval length in effect, the number of bits used for the angle may change. For the 5 km intervals, 10 bits for the angle and 8 bits for the difference in angle may be used. This provides a resolution of +/−15 meters. Other alternatives also may be used, as shown in TABLE 13.

TABLE 13

| Interval length | | Resolution | Normal Angle | Small Angle |
|---|---|---|---|---|
| 100 | meters | +/−1.25 meters | 8 bits | 6 bits |
| 1 | km | +/−6.25 meters | 9 bits | 7 bits |
| 5 | km | +/−16 meters | 10 bits | 8 bits |
| 20 | km | +/−31 meters | 11 bits | 9 bits |

Though reference is made to compressing location information, the techniques and structures described here may be used to compress, transmit, decompress, and store other types of information. For example, standardized image formats, such as bitmaps, JPEG and other similar imaging formats, which may be scaled for a typical screen size for a computer monitor or laptop screen, may or may not provide appropriate resolution or size efficiency for viewing on devices such as mobile phones or PDA's, where the view screen can be much smaller. Some conventional graphical user interface designs, image processing, storage and transport systems utilize vector based graphics to increase the usability and performance of the images they create, which yield images that can be scaled to almost any size yet provide an almost perfect rendering of the image for viewing. Maps, web browsers and other informational imaging interfaces are example devices that benefit from the use of such an imaging format. In some implementations, the compressor 146 may be used to compress these types of data files, where some or all of the algorithm steps described here are used to reduce the amount of data needed to describe vector based information within any number and or type of imaging data formats.

In some implementations, location information contained in a Wi-Fi lookup, cellular identification lookup or other location data file type (hereinafter “tile”) may be compressed. In some implementations, individual tiles may contain any number and type of unique device IDs, logically associated with unique locations (hereinafter “geotagged ID”). When the mobile unit 200/300 (e.g., a mobile phone) captures and decodes a Wi-Fi RF signal to extract a decoded Wi-Fi ID, the decoded Wi-Fi ID may be compared to the geotagged Wi-Fi ID contained in the tile. When a matching ID is found, the mobile unit may be assumed to be at or near the same geotagged location as the decoded Wi-Fi ID. For example, a tile may describe 1000 Wi-Fi IDs and their associated geotagged locations within the tile representing a two-square-kilometre region. In this example, when the mobile unit is located within the region, the mobile unit may detect and decode any of the Wi-Fi IDs for matching purposes. In another example, any number of mobile units with one or more RF receivers may detect such Wi-Fi IDs within the region, and may add any new ID to the tile information. The detected IDs and the newly added ID may be stored as a new compressed information packet, which may be transmitted at a later time.

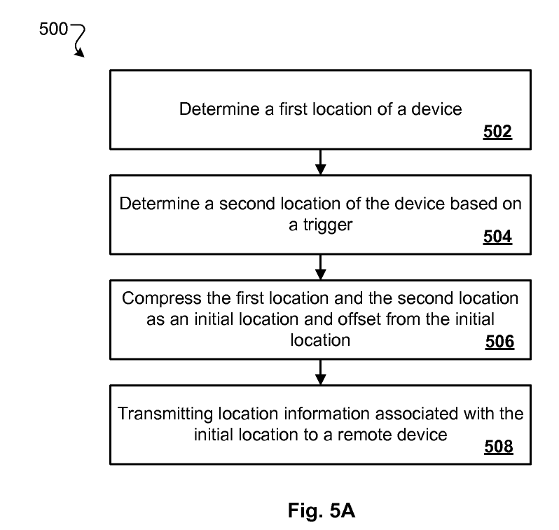

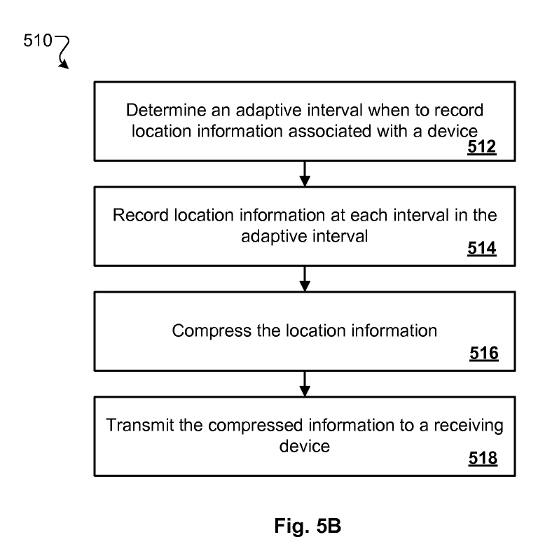

FIG. 5A is a flow diagram showing an example process 500 for compressing location information. The process 500 may be performed, for example, by the GPS network 100, and for clarity of presentation, the description that follows uses the GPS network 500 as the basis of examples for describing the process 500. However, another apparatus, system, or combination of systems, may be used to perform the process 500.

As shown in FIG. 5A, process 500 begins with determining an initial location of a device (502). In some implementations, the device may be in motion. Alternatively, the device may be stationary. Based on a trigger, a second location of the device also may be determined (504). In some implementations, the trigger may include a predetermined amount of time. For example, after a predetermined of time, the second location of the device may be determined. In other implementations, the trigger may include a distance traveled by the device. In such implementations, if the device is in motion, then the distance may be determined based on the first location and the location detected based on the trigger. The trigger also may be adaptively configured to change over the course of time.

In some implementations, the trigger also may include a distance associated with a third location. For example, a third location of the device may be determined, where the trigger to determine the second location of the device and the third location of the device may be the same or different.

After obtaining the first location and the second location of the device, the first location and the second location may be compressed as an initial location and an offset from the initial location (506). In some implementations, compressing may include determining a resolution of a delta between the first location and the second location. In some implementations, compressing also may include setting a bit width of the information used to store the second location based on the delta. If the delta is less than a threshold, compressing further may include reducing the bitwidth of an interval associated with the first and second locations. Alternatively, compressing may include reducing a bitwidth used to store the second location based on interval length. In yet other implementations, compressing may include determining when the device stops between the first and second location and compressing the interval defined by the first and second location as a stop that reflects no change in the device location.

In some implementations, the offset may include an angle, a distance or a combination thereof. The angle and the distance may describe the angle and the distance between the first location and the second location. Location information associated with the initial location may be transmitted to a remote device (508).

In some implementations, operations 502-508 may be performed in the order listed, in parallel (e.g., by the same or a different process, substantially or otherwise non-serially), or in reverse order to achieve the same result. In another implementations, operations 502-508 may be performed out of the order shown. Also, the order in which the operations are performed may depend, at least in part, on what entity performs the method. Operations 502-508 further may be performed by the same or different entities or systems.

FIG. 5B is a flow diagram showing an alternative process 510 for compressing location information. The process 510 may be performed, for example, by the GPS network 100, and for clarity of presentation, the description that follows uses the GPS network 500 as the basis of examples for describing the process 510. However, another apparatus, system, or combination of systems, may be used to perform the process 510.

Process 510 begins with determining an adaptive interval when to record location information associated with a device (512). In some implementations, determining an adaptive interval when to record location information associated with a device may include determining an adaptive interval when to record location information associated with a device without requiring a user to select a fixed time interval, or a fixed distance interval in advance.

In some implementations, determining an adaptive interval may include evaluating a flow of GPS information available, determining a performance threshold to achieve, and determining a current interval based on the flow information and the performance threshold.

Location information at each interval in the adaptive interval may be recorded (514). The location information may then be compressed (516), and the compressed information may be transmitted to a receiving device (518). In some implementations, compressing the location information may include evaluating individual locations based on a relationship between the locations, rather than describing the locations themselves. In some implementations, evaluating individual locations may include evaluating all the locations that are available, and placing each in an organizational structure in a sequence that minimizes the total spatial distances between each location. The organizational structure, in some implementations, may be a route.

In some implementations, operations 512-518 may be performed in the order listed, in parallel (e.g., by the same or a different process, substantially or otherwise non-serially), or in reverse order to achieve the same result. In another implementations, operations 512-518 may be performed out of the order shown. Also, the order in which the operations are performed may depend, at least in part, on what entity performs the method. Operations 512-518 further may be performed by the same or different entities or systems.

### Generic Computer System

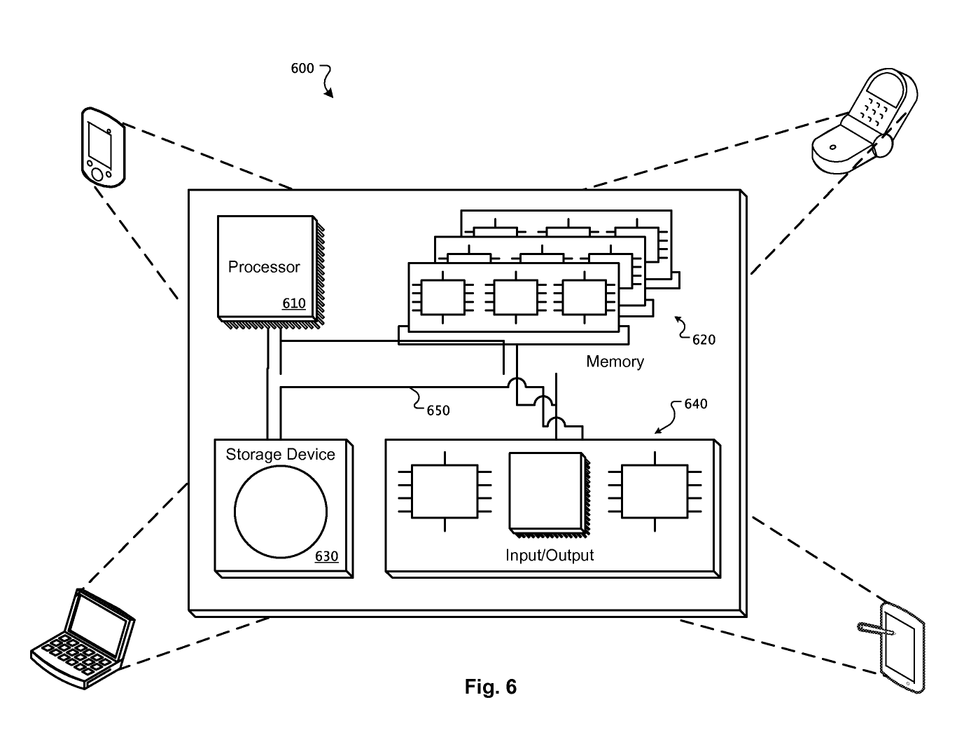

FIG. 6 is a block diagram of a generic processing device 600 that may be used, for example, as a component of the mobile unit 110/120. The device 600 may be used for the operations described in association with processes 500 and 510 according to one implementation.

As shown, the device 600 includes a processor 610, a memory 620, a storage device 630, and an input/output device 640. Each of the components 610, 620, 630, and 640 are interconnected using a bus 650. The processor 610 is capable of processing instructions for execution within the device 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the device 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the device 600. In one implementation, the storage device 630 is a computer-readable medium. In various different implementations, the storage device 630 may be a hard disk device, an optical disk device, or a flash drive. The storage device 630 may be used, for example, to store information associated with various geographic locations.

The input/output device 640 provides input/output operations for the device 600. In one implementation, the input/output device 640 includes a keyboard and/or pointing device. In another implementation, the input/output device 640 includes a display unit for displaying graphical user interfaces.

Embodiments of aspects the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on an information carrier medium for execution by, or to control the operation of, data processing apparatus.

The term “data processing apparatus” encompasses all apparatus, devices, and machines for processing data, including by way of example a programmable processor (also know as a CPU (central processing unit)), a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer-readable medium can be a machine-readable storage device, a machine-readable storage substrate, a memory device, or a combination of one or more of them. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

An information carrier medium can be a propagated signal or a computer-readable medium. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a GPS receiver, to name just a few.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results.

What is claimed is:

1. A method comprising:
determining a first location of a device;
based on a trigger, determining a second location of the device;
compressing the first location and second location as an initial location and an offset from the initial location, where the offset is an angle and a distance; and
transmitting location information associated with the initial location to a remote device.

2. The method of claim 1, where the trigger is an amount of time.

3. The method of claim 1, where the trigger is a distance traveled.

4. The method of claim 1, where the trigger is adaptively configured to change over the course of time that location information is compressed and transmitted.

5. The method of claim 4, where the trigger is a distance, the method further comprising determining a third location of the device, and where the trigger to determine the second location of the device and the third location of the device is different.

6. The method of claim 1, further comprising:
determining if the second location is insubstantially different from the first location in at least one aspect; and
if so, compressing the second location as only a distance from the first location.

7. The method of claim 1, where the first location is of the form of a NMEA type location information prior to compression.

8. The method of claim 1, where the compressing includes determining a resolution of a delta between the first location and the second location and further comprising setting a bit width of the information used to store the second location based on the delta.

9. The method of claim 8, wherein if the delta is less than a threshold, compressing includes reducing the bitwidth of an interval associated with the first and second locations.

10. The method of claim 8, wherein the compressing includes reducing a bitwidth used to store the second location based on interval length.

11. The method of claim 1, where compressing includes determining when the device stops between the first and second location and compressing the interval defined by the first and second location as a stop that reflects no change in the device location.

12. A method comprising:
determining an adaptive interval when to record location information associated with a device without requiring a user to select a fixed time interval, or a fixed distance interval in advance;
recording location information at each interval in the adaptive interval;
compressing the location information; and
transmitting the compressed information to a receiving device.

13. The method of claim 12, wherein determining an adaptive interval includes:
evaluating a flow of GPS information available;
determining a performance threshold to achieve; and
determining a current interval based on the flow information and the performance threshold.

14. The method of claim 12, wherein compressing the location information further comprises evaluating individual locations based on a relationship between the locations, rather than describing the locations themselves.

15. The method of claim 14, further comprising evaluating all the locations that are available, and placing each in an organizational structure in a sequence that minimizes the total spatial distances between each location.

16. The method of claim 15, where the organizational structure is a route.

17. A device comprising:
a detector to determine a first location of the device, and a second location of the device based on a first trigger;
a compressor to compress the first location and second location as an initial location and an offset from the initial location, where the offset is an angle and a distance; and
a transmitter to transmit location information associated with the initial location to a remote device.

18. The device of claim 17, wherein the first trigger is adaptively configured to change over the course of time that location information is compressed and transmitted.

19. The device of claim 18, wherein:
the first trigger is associated with a distance, where the detector is further configured to determine a third location of the device based on a second trigger, the first trigger to determine the second location of the device and the second trigger to determine the third location of the device being different.

20. The method of claim 17, wherein the detector is further configured to determine if the second location is insubstantially different from the first location in at least one aspect, and compresses the second location as only a distance from the first location if the second location is insubstantially different from the first location in at least one aspect.
